(19) United States
(12) Patent Application Publication
(10) Pub. No.: US 2008/0243829 A1
(43) Pub. Date: Oct. 2, 2008

(54) SPECTRAL CLUSTERING USING SEQUENTIAL SHRINKAGE OPTIMIZATION

(75) Inventors: Tie-Yan Liu, Beijing (CN); Wei-Ying Ma, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/767,626

(22) Filed: Jun. 25, 2007

Related U.S. Application Data
(60) Provisional application No. 60/908,761, filed on Mar. 29, 2007.

(51) Int. Cl. G06F 17/30

(52) U.S. Cl. 707/5; 707/E17.001

(57) ABSTRACT

A clustering system initially applies an eigenvalue decomposition solver for a number of iterations to a clustering objective function. The eigenvalue decomposition solver generates an eigenvector that is an initial approximation of a solution to the objective function. The clustering system fixes the eigenvector values for the identified objects. The clustering system then reformulates the objective function to focus on the objects whose clusters have not yet been determined. The clustering system then applies an eigenvalue decomposition solver for a number of iterations to the reformulated objective function to generate new values for the eigenvector for the objects whose clusters have not yet been determined. The clustering system then repeats the process of identifying objects, reformulating the objective function, and applying an eigenvalue decomposition solver for a number of iterations until a termination criterion is satisfied.

### CROSS-REFERENCE TO RELATED APPLICATION(S)

This application claims the benefit of U.S. Provisional Application No. 60/908,761 entitled “FAST LARGE-SCALE SPECTRAL CLUSTERING BY SEQUENTIAL SHRINKAGE OPTIMIZATION,” filed on Mar. 29, 2007, which application is hereby incorporated by reference in its entirety.

### BACKGROUND

The development of information systems, such as the Internet, and various online services for accessing the information systems has led to the availability of increasing amounts of information. As computers become more powerful and versatile, users are increasingly employing their computers for a broad variety of tasks. Accompanying the increasing use and versatility of computers is a growing desire on the part of users to rely on their computing devices to perform their daily activities. For example, anyone with access to a suitable Internet connection may go “online” and navigate to the information pages (i.e., the web pages) to gather information that is relevant to the user's current activity.

Many search engine services, such as Google and Yahoo!, provide for searching for information that is accessible via the Internet. These search engine services allow users to search for display pages, such as web pages, that may be of interest to users. After a user submits a search request (i.e., a query) that includes search terms, the search engine service identifies web pages that may be related to those search terms. To quickly identify related web pages, the search engine services may maintain a mapping of keywords to web pages. This mapping may be generated by “crawling” the web (i.e., the World Wide Web) to identify the keywords of each web page. To crawl the web, a search engine service may use a list of root web pages to identify all web pages that are accessible through those root web pages. The keywords of any particular web page can be identified using various well-known information retrieval techniques, such as identifying the words of a headline, the words supplied in the metadata of the web page, the words that are highlighted, and so on. The search engine service may generate a relevance score to indicate how relevant the information of the web page may be to the search request based on the closeness of each match, web page importance or popularity (e.g., Google's PageRank), and so on. The search engine service then displays to the user links to those web pages in an order that is based on a ranking determined by their relevance.

Unfortunately, users of the information systems may encounter an information overload problem. For example, the search engine services often provide users a large number of search results, thus forcing the users to sift through a long list of web pages in order to find the relevant web pages.

Clustering techniques have been used to help organize objects that are similar or in some way related. These objects can include people, documents, web sites, events, news stories, and so on. For example, if the web pages of a search result are clustered based on similarity to one another, then the user can be presented with a list of the clusters, rather than a list of individual documents. As a result, the user will be presented with clusters of documents covering diverse topics on the first web page of the search result, rather than a listing of individual documents that may all be very similar. Because of the large numbers of web-based objects (e.g., web pages, blocks of web pages, images of web pages, and web sites), it can be very computationally expensive to cluster such objects.

Spectral clustering techniques have proved effective at clustering objects. The use of spectral clustering has, however, been mainly restricted to small-scale problems because of its high computational complexity. Spectral clustering represents the objects to be clustered and the relationship between the objects as a graph. A graph may be represented as G=<V, E, W>, where V={1, 2, . . . , n} is the set of vertices, E={<i,j >|i,j ε V} is the set of edges, and W is a diagonal matrix with the diagonal elements set to the weights of the objects. The vertices of the graph represent the objects, and the edges represent the relationship between the objects. A graph can be represented by a relationship or adjacency matrix M as represented by the following

$${M}_{ij} = \{ \begin{matrix}{e}_{ij} & if < i , j > ∈ E \\ 0 & otherwise\end{matrix} \qquad ( 1 )$$

where Mᵢⱼ is set to the weight eᵢⱼ of the relationship when there is a relationship from a source object i to a target object j. For example, the relationship matrix can represent a directed web graph in which the objects are web pages, the relationships may represent links with weights from a source web page to a target web page, and the weights of the web pages may represent the importance of the web pages. As another example, the relationship matrix can represent an undirected document graph of a collection of documents in which the objects are documents and the relationships represent the similarity (e.g., cosine similarity) between the documents represented by the relationship weights with the object weights all being set to 1. The goal of spectral clustering is to identify clusters of related objects.

Spectral clustering can be described as partitioning a graph into two clusters and recursively applying the two-way partitioning to partition the graph into more clusters. The goal of spectral clustering is to partition the graph so that an objective function is minimized. One objective function may be to minimize the cut, that is, ensure that the relationships represented by the edges that are cut are minimized. Another objective function, referred to as “ratio cut,” balances the ratio of the weight of the relationship weights of the cut to the weight of the objects within a cluster, and another objective function, referred to as “normalized cut,” balances the cluster weights. The membership of the objects in two clusters A and B can be represented by the following:

$${q}_{i} = \{ \begin{matrix}1 & if i ∈ A \\ - 1 & if i ∈ B\end{matrix} \qquad ( 2 )$$

where q, represents an indicator of the cluster that contains object i. If q, is 1, then the object is in cluster A; and if q, is −1, then the object is in cluster B. The objective function can be represented by the following:

$$obj ( {V}_{1} , {V}_{2} ) = \frac{cut ( {V}_{1} , {V}_{2} )}{weight ( {V}_{2} )} + \frac{cut ( {V}_{2} , {V}_{1} )}{weight ( {V}_{1} )} \qquad ( 3 )$$

where obj (V₁,V₂) represents the objective function to be minimized, cut (V₁,V₂) is represented by the following:

cut(V₁,V₂)=Σ_{iεV}_{₁}_{,jεV}_{₂}_{,<i,j>εE}^{e}ᵢⱼ (4)

and weight (V₁) is represented by the following:

weight(V₁)=Σ_{jεVi}^{W}ⱼ (5)

where i represents the cluster.

The objective function of Equation 2 can be rewritten by defining the indicators of the cluster that contains an object by the following:

$${q}^{( i )} = \{ \begin{matrix}+ \sqrt{\frac{{η}_{2}}{{η}_{1}}} & if i ∈ {V}_{1} \\ - \sqrt{\frac{{η}_{1}}{{η}_{2}}} & if i ∈ {V}_{2}\end{matrix} \qquad ( 6 )$$

where n, represents weight (Vᵢ). The objective function can be rewritten as a Rayleigh quotient as represented by the following:

$$min \frac{{q}^{T} Lq}{{q}^{T} Wq} , s . t . {q}^{T} We = 0 \qquad ( 7 )$$

where L=W−M. If q, is represented as continuous values, rather than discrete values, then the solution to the objective function can be represented by the eigenvectors of the following:

Lν=λWν (8)

where q represents an eigenvector ν and λ represents an eigenvalue and the solution is equal to the eigenvector associated with the second smallest eigenvalue. A k-way spectral clustering may correspond to solving the k smallest eigenvalues and their corresponding eigenvectors, rather than applying binary clustering recursively.

Traditionally, spectral clustering first performs an eigenvalue decomposition (“EVD”), and then some heuristics such as k-means are applied to the eigenvectors to obtain the discrete clusters. Unfortunately, eigenvalue decomposition is computationally expensive. For example, the Lanczos algorithm is O(mn²k) and the preconditioned conjugate gradient (“CG-based”) algorithm is O(n²k), where k is the number of the eigenvectors used, n is the number of data points, and m is the number of iteration steps. (See Sorensen, D. C., “Implicitly Restarted Arnoldi/Lanczos Methods for Large-Scale Eigenvalue Calculations,” Technical Report, TR-96-40, 1996, and Knyazev, A. V., “Toward the Optimal Preconditioned Eigensolver: Locally Optimal Block Preconditioned Conjugate Gradient Method,” SIAM Journal on Scientific Computing, vol. 23, no. 2, pp. 517-541, 2001.)

### SUMMARY

Spectral clustering using linear or nonlinear sequential shrinkage optimization by iteratively identifying objects belonging to clusters and then establishing the clusters of those objects in subsequent iterations is provided. A clustering system initially applies an eigenvalue decomposition solver for a number of iterations to a clustering objective function. The eigenvalue decomposition solver generates an eigenvector that is an initial approximation of a solution to the objective function. Each value of the eigenvector corresponds to an object. The clustering system identifies objects whose clusters can be determined based on the values of the eigenvector as indicators of the clusters. The clustering system fixes the eigenvector values for the identified objects. The clustering system then reformulates the objective function to focus on the objects whose clusters have not yet been determined. The clustering system then applies an eigenvalue decomposition solver for a number of iterations to the reformulated objective function to generate new values for the eigenvector for the objects whose clusters have not yet been determined. The clustering system then repeats the process of identifying objects whose clusters have been determined, reformulating the objective function to focus on objects whose clusters have not yet been determined, and applying an eigenvalue decomposition solver for a number of iterations until a termination criterion is satisfied.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates components of the clustering system based on spectral clustering in one embodiment.

FIG. 2 is a flow diagram that illustrates the processing of the nonlinear sequential shrinkage optimization component of the clustering system in one embodiment.

FIG. 3 is a flow diagram that illustrates the processing of the linear sequential shrinkage optimization component of the clustering system in one embodiment.

### DETAILED DESCRIPTION

Spectral clustering using linear or nonlinear sequential shrinkage optimization by iteratively identifying objects belonging to clusters and then establishing the clusters of those objects in subsequent iterations is provided. In some embodiments, a clustering system clusters objects having relationships using nonlinear sequential shrinkage optimization by representing the clustering as a nonlinear optimization problem that can be solved using a nonlinear eigenvalue decomposition solver. The clustering system initially applies a nonlinear eigenvalue decomposition solver for a few iterations to a nonlinear objective function. The nonlinear eigenvalue decomposition solver generates an eigenvector that is an initial approximation of a solution to the objective function. Each value of the eigenvector corresponds to an object. The values of the eigenvector for some objects tend to converge on the indicator values or solution quicker (e.g., after a few iterations) than the values of other objects. The clustering system identifies those objects based on closeness of those values of the eigenvector to the indicator values of the clusters. For example, when the clustering system performs binary clustering, it identifies the values that are near either indicator values for the clusters. After identifying those objects, the clustering system fixes their values in the eigenvector to the indicator values of the clusters to which they belong. The clustering system then reformulates the objective function to focus on the objects whose clusters have not yet been determined. This reformulation reduces the size of the nonlinear problem that is yet to be solved. The clustering system then applies a nonlinear eigenvalue decomposition solver for a few iterations to generate new values for the eigenvector, which has fewer values that need to be calculated because some of the values have been fixed. The clustering system then repeats the process of identifying objects that belong to clusters, reformulating the objective function to focus on objects not yet identified, and applying a nonlinear eigenvalue decomposition solver for a few iterations until a termination criterion is satisfied. For example, the termination criterion may be satisfied when all the objects have been identified as belonging to clusters. Because the size of the optimization problem sequentially shrinks at each reformulation, the clustering system sequentially solves increasingly smaller problems, which is less computationally expensive than applying a nonlinear eigenvalue decomposition solver to the original objective function representing all the objects until the eigenvector converges on a final solution for all objects.

In some embodiments, the clustering system uses linear sequential shrinkage optimization to reformulate a nonlinear objective function into a linear objective function and uses a linear eigenvalue decomposition solver to cluster the objects. The clustering system initially applies a nonlinear eigenvalue decomposition solver for a few iterations to provide an approximate solution to a nonlinear objective function. The nonlinear objective function specifies the clustering of the objects based on the relationship weights between objects and the weights of the objects. The clustering system identifies from the approximate eigenvector of the solution those objects that are indicated as belonging to clusters. The clustering system then fixes the values of the eigenvector for those objects. The clustering system then reformulates the objective function to focus on the objects that have not yet been identified as belonging to clusters and so that the object weights dominate the relationship weights. Because the object weights dominate the relationship weights, the nonlinear objective function can be approximated as a linear objective function (as described below in detail). This reformulation also reduces the size of the nonlinear problem that is yet to be solved. The clustering system then applies a linear eigenvalue decomposition solver for a few iterations to generate new values for the eigenvector. The clustering system then repeats the process of identifying objects that belong to clusters, reformulating the objective function to focus on objects not yet identified and so that the object weights dominate the relationship weights, and applying a linear eigenvalue decomposition solver for a few iterations until a termination criterion is satisfied. Because the size of the optimization problem sequentially shrinks at each reformulation and the optimization is transformed into a linear optimization problem, the clustering system sequentially solves increasingly smaller problems that are linear, which is less computationally expensive than applying a nonlinear eigenvalue decomposition solver to the original objective function representing all the objects until the eigenvector converges on a solution or applying a nonlinear eigenvalue decomposition solver to the reformulated objective function.

In some embodiments, the clustering system may use any of a variety of eigenvalue decomposition solvers. For example, the clustering system may use a conjugate gradient eigenvalue decomposition solver. (See Golub, G. H., and Loan, C. F. V., “Matrix Computations,”.Johns Hopkins University Press, 1996.) A linear conjugate gradient solver solves a quadratic optimization problem as represented by the following:

$$min f ( q ) = \frac{1}{2} {q}^{T} Aq - {b}^{T} q + c \qquad ( 9 )$$

Many conjugate gradient solvers solve general continuous optimization problems that are nonlinear. The solvers are referred to as nonlinear conjugate gradient solvers. (See Golub, G. H., and Loan, C. F. V., “Matrix Computations,” Johns Hopkins University Press, 1996; Nocedal, J., and Wright, S. J., “Numerical Optimization,” Springer Series in Operations Research, 2000.) As a special case, a generalized eigenvalue decomposition problem can also be solved using a nonlinear conjugate gradient solver, because the problem is equivalent to a continuous optimization problem as represented by the following:

$$\{ \begin{matrix}min & {q}^{T} Aq \\ s . t . & {q}^{T} Wq = 1\end{matrix} \qquad ( 10 )$$

(See Knyazev, A. V., “Toward the Optimal Preconditioned Eigensolver: Locally Optimal Block Preconditioned Conjugate Gradient Method,” SIAM Journal on Scientific Computing, 2001; Knyazev, A. V., “Preconditioned Eigensolvers: Practical Algorithms,” Technical Report: UCD-CCM 143, University of Colorado at Denver, 1999.)

In some embodiments, the clustering system represents the eigenvector generated by an eigenvalue decomposition solver at each sequential iteration that reformulates the objective function by the following:

q=[q₁,q₂]^{T} (11)

where q₁ represents the values of the eigenvector that have converged on a solution indicating the cluster of the corresponding object and q₂ represents the values that have not yet converged. According to Equation 7, the solution q should be the conjugate orthogonal to e. The clustering system adjusts the values for the objects identified as belonging to clusters to ensure that q, is the conjugate orthogonal to e₁ as represented by the following:

q₁^{T}We₁=0 (12)

The clustering system adjusts each value of the eigenvector to a fixed value as represented by the following:

$${q}_{1}^{( i )} = \{ \begin{matrix}+ \sqrt{\frac{{η}_{2}}{{η}_{1}}} {q}_{1}^{( i )} > 0 \\ - \sqrt{\frac{{η}_{1}}{{η}_{2}}} {q}_{1}^{( i )} < 0\end{matrix} \\ where \\ {η}_{1} = {\sum }_{{q}_{1}^{( i )} > 0 , i ∈ {V}^{F}} {W}_{i} , {η}_{2} = {\sum }_{{q}_{1}^{( i )} < 0 , i ∈ {V}^{F}} {W}_{i} . \qquad ( 13 )$$

The clustering system then divides the matrix L and W into blocks to represent the portions corresponding to the fixed values of the eigenvector as represented by the following:

$$L = [ \begin{matrix}{L}_{1} & {L}_{12} \\ {L}_{21} & {L}_{2}\end{matrix} ] , W = [ \begin{matrix}{W}_{1} & \\ & {W}_{2}\end{matrix} ] \qquad ( 14 )$$

where L₁, L₁₂, L₂₁, and L₂ represent matrices of sizes p-by-p, p-by-(n-p), (n-p)-by-p, and (n-p)-by-(n-p), respectively, n represents the number of objects, and p represents the number of objects in q₁. The clustering system reformulates the objective function as represented by the following:

$$min \frac{{[ \begin{matrix}{q}_{1} \\ {q}_{2}\end{matrix} ]}^{T} [ \begin{matrix}{L}_{1} & {L}_{12} \\ {L}_{21} & {L}_{2}\end{matrix} ] [ \begin{matrix}{q}_{1} \\ {q}_{2}\end{matrix} ]}{{[ \begin{matrix}{q}_{1} \\ {q}_{2}\end{matrix} ]}^{T} [ \begin{matrix}{W}_{1} & \\ & {W}_{2}\end{matrix} ] [ \begin{matrix}{q}_{1} \\ {q}_{2}\end{matrix} ]} , \\ s . t . {[ \begin{matrix}{q}_{1} \\ {q}_{2}\end{matrix} ]}^{T} [ \begin{matrix}{W}_{1} & \\ & {W}_{2}\end{matrix} ] [ \begin{matrix}{e}_{1} \\ {e}_{2}\end{matrix} ] = 0 \qquad ( 15 )$$

This reformulated objective function can be equivalently represented by the following:

$$\begin{matrix}min T ( {q}_{2} ) = \frac{{q}_{2}^{T} {L}_{2} {q}_{2} + 2 {q}_{1}^{T} {L}_{12} {q}_{2} + {q}_{1}^{T} {L}_{1} {q}_{1}}{{q}_{2}^{T} {W}_{2} {q}_{2} + {q}_{1}^{T} {W}_{1} {q}_{1}} & ( 16 ) \\ s . t . {q}_{2}^{T} {W}_{2} {e}_{2} + {q}_{1}^{T} {W}_{1} {e}_{1} = 0 & ( 17 )\end{matrix}$$

where q₁^{T}W₁q₁ and q₁^{T}L₁q₁ are fixed and represent the sequential shrinkage of the optimization problem. The constraint of Equation 17 is gradually satisfied when more and more values of the eigenvector are fixed. The clustering system iteratively applies a nonlinear conjugate gradient eigenvalue decomposition solver, or any other appropriate eigenvalue decomposition solver, for a few iterations to each reformulated objective function. The scale of the optimization problem is thus reduced at each application of the eigenvalue decomposition solver. In addition, the fixed values of the eigenvector identify the clusters to which the objects belong.

Although the nonlinear sequential shrinkage optimization technique as described above can speed up spectral clustering, finding the solution to a nonlinear objective function is computationally complex because of its nonlinearity. In some embodiments, the clustering system reformulates the objective function to be linear so that it can be solved by a linear eigenvalue decomposition solver. The clustering system removes the denominator of Equation 16 and preserves its numerator to reformulate it as a linear objective function. The linear objective function can be represented in a format similar to that of Equation 9 as follows:

H(q₂)=q₂^{T}L₂q₂+2q₁^{T}L₁₂q₂+q₁^{T}L₁q₁ (18)

Under certain conditions, the solution to Equation 16 can be approximated by a solution to Equation 18. In particular, the solution of Equation 18, q₂*, and the solution of Equation 16, q₂**, satisfy an equality as represented by the following:

q₂**=λq₂* (19)

Since the scaling of the solution will not affect the clustering results, the solution to the linear objective function will approximate the solution of the nonlinear objective function. The condition under which the linear solution approximates the nonlinear solution is represented by the following:

W₂L₂⁻¹=1 (20)

When most of the values in the eigenvector are fixed, the size of W₂ is much smaller than the size of W₁. As a result, the condition of Equation 20 is satisfied. Since W₂ is a diagonal matrix consisting of the diagonal elements of L₂, L₂ is a strongly dominant diagonal when most of the values are fixed. Nevertheless, when most of the values are not fixed, the condition of Equation 20 might not be satisfied. The clustering system uses a preprocessing step to force the condition to be satisfied in a way that will not change the final clustering.

To force the condition to be satisfied, the clustering system represents the general eigenvalue decomposition problem by the following:

Lq=λWq (21)

where q represents an eigenvector and λ represents an eigenvalue. The eigenvector q is also an eigenvector of the eigenvalue problem as represented by the following:

$$( L + tW ) q = \frac{λ + t}{t + 1} ( W + tW ) q \qquad ( 22 )$$

The addition of tW to both W and L does not affect the resulting eigenvectors and thus clustering of the objects. If t is sufficiently large, then L will become a dominant diagonal and thus the condition of Equation 20 will be satisfied. As a result, except for the initial application of the eigenvalue decomposition solver, the clustering system can apply a linear eigenvalue decomposition solver when the objective function is to reformulated to remove the denominator and to add tW to make L a dominant diagonal.

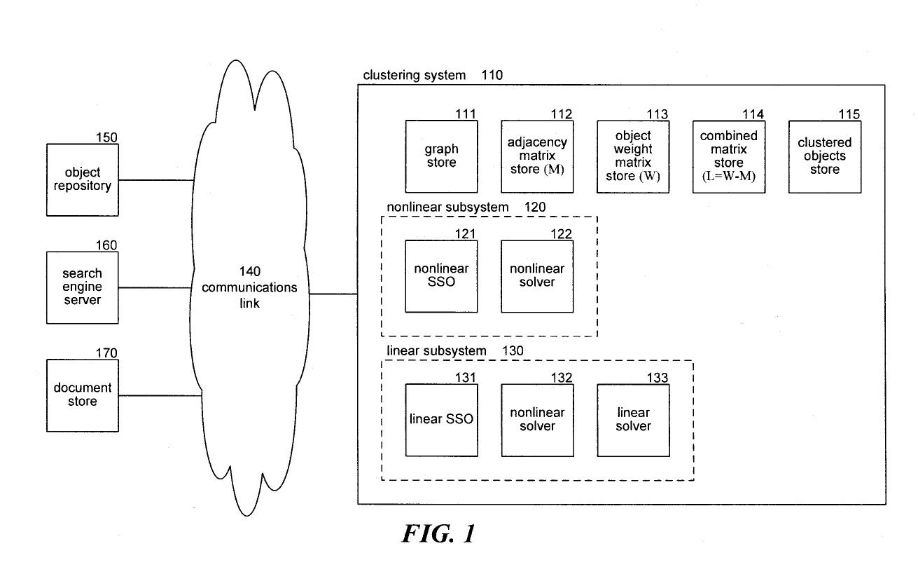

FIG. 1 is a block diagram that illustrates components of the clustering system based on spectral clustering in one embodiment. A clustering system 110 may be connected to various object repositories such as an object repository 150, a search engine server 160, and a document store 170 via communications link 140. Various object repositories may provide graph information representing objects to the clustering system and receive the clusterings of objects in return. The clustering system may include a graph store 111, an adjacency matrix store 112, an object weight matrix store 113, a combined matrix store 114, and a clustered objects store 115. The graph store may contain graph information such as the identification of objects, relationships between objects, weights of objects, and weights of relationships. The adjacency matrix store may contain an adjacency matrix M representing the relationship weights of the objects. The object weight matrix store may contain a weight matrix W that is a diagonal matrix of the object weights. The combined matrix store may contain a combined matrix L for the objects. The clustered objects store contains a clustering of the objects as represented by the final values of the eigenvector.

The clustering system may include a nonlinear subsystem 120 and a linear subsystem 130. The nonlinear subsystem includes a nonlinear sequential shrinkage optimization component 121 and a nonlinear eigenvalue decomposition solver 122. The nonlinear sequential shrinkage optimization component iteratively applies the nonlinear solver and identifies eigenvector values that have converged on a solution indicating the cluster of the corresponding object. The linear subsystem includes a linear sequential shrinkage optimization component 131, a nonlinear eigenvalue decomposition solver 132, and a linear eigenvalue decomposition solver 133. The linear sequential shrinkage optimization component applies the nonlinear eigenvalue decomposition solver initially and then iteratively applies the linear eigenvalue decomposition solver to the objective function reformulated as a linear objective function.

The computing device on which the clustering system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the clustering system, which means a computer-readable medium that contains the instructions. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented and used in various operating environments that include personal computers, server computers, hand-held or laptop devices, multiprocessor systems, microprocessor-based systems, programmable consumer electronics, digital cameras, network PCs, minicomputers, mainframe computers, computing environments that include any of the above systems or devices, and so on.

The clustering system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, separate computing systems may generate the various matrices, and the clustering system may implement only the nonlinear sequential shrinkage optimization or only the linear sequential shrinkage optimization. The clustering system may also be implemented as part of an object repository.

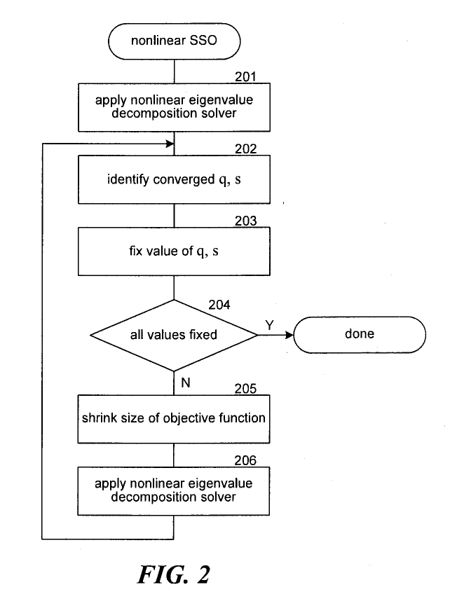

FIG. 2 is a flow diagram that illustrates the processing of the nonlinear sequential shrinkage optimization component of the clustering system in one embodiment. The component may be invoked after the adjacency matrix, the object weight matrix, and the combined matrix are generated from the information of the graph store. The component returns an indication of the cluster of each object. In block 201 the component applies a nonlinear eigenvalue decomposition solver for a few iterations to the objective function as represented by Equation 16. The number of iterations that is performed at each application of an eigenvalue decomposition solver may be learned. In general, it may be set to less than 1% of scale of the problem as represented, for example, by the number of objects. In block 202, the component identifies objects as belonging to clusters based on the values of the eigenvector returned by the nonlinear eigenvalue decomposition solver that have converged on a solution. In block 203, the component fixes the values of the identified objects according to Equation 13. In decision block 204, if the termination criterion is satisfied (e.g., all the values have converged on a solution), then the component completes, else the component continues at block 205. In block 205, the component shrinks the size of the objective function based on the fixed values. In block 206, the component applies a nonlinear eigenvalue decomposition solver to the reformulated objective function and then loops to block 202 to identify the objects whose values have converged.

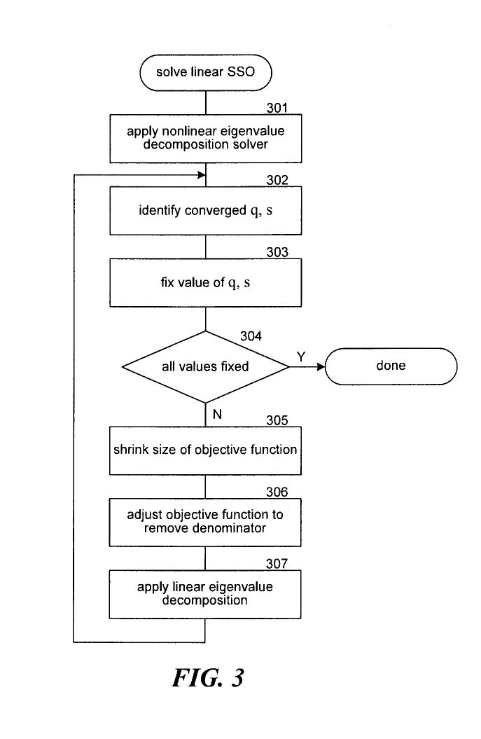

FIG. 3 is a flow diagram that illustrates the processing of the linear sequential shrinkage optimization component of the clustering system in one embodiment. The component may be invoked after the adjacency matrix, the object weight matrix, and the combined matrix are generated from the information of the graph store. The component returns an indication of the cluster of each object. In block 301, the component applies a nonlinear eigenvalue decomposition solver for a few iterations to the objective function as represented by Equation 16. The number of iterations that is performed at each application of an eigenvalue decomposition solver may be learned. In general, it may be set to less than 1% of scale of the problem as represented, for example, by the number of objects. In block 302, the component identifies objects as belonging to clusters based on the values of the eigenvector returned by the nonlinear eigenvalue decomposition solver that have converged on a solution. In block 303, the component fixes the values of the identified objects according to Equation 13. In decision block 304, if the termination criterion is satisfied (e.g., all the values have converged on a solution), then the component completes, else the component continues at block 305. In block 305, the component shrinks the size of the objective function based on the fixed values. In block 306, the component adjusts the objective function to be linear by removing the denominator and ensuring that the condition of Equation 20 is satisfied. In block 307, the component applies a linear eigenvalue decomposition solver to the reformulated objective function and then loops to block 302 to identify the objects whose values have converged.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The clustering system may be used by various applications (e.g., search engines, information retrieval systems) to cluster objects of various types with relationships. Accordingly, the invention is not limited except as by the appended claims.

I/we claim:

1. A method in a computing device for clustering objects having relationships, the method comprising:
applying a nonlinear eigenvalue decomposition solver to a clustering objective function for a number of iterations to generate an approximate solution represented by an eigenvector with a value for each object representing the cluster to which the object belongs; and
repeating the following until a termination criterion is satisfied:
identifying objects whose clusters have been determined as indicated by the values of the eigenvector;
reformulating the objective function to focus on the objects whose clusters have not yet been determined; and
applying a nonlinear eigenvalue decomposition solver to the reformulated objective function for a number of iterations to generate an eigenvector representing an approximate solution.

2. The method of claim 1 wherein the termination criterion is satisfied when the clusters of all the objects have been determined.

3. The method of claim 1 wherein the objective function is represented by the following:
$$min \frac{{q}^{T} Lq}{{q}^{T} Wq} , s . t . {q}^{T} We = 0$$

4. The method of claim 3 wherein the reformulated objective function is represented by the following:
$$min \frac{{[ \begin{matrix}{q}_{1} \\ {q}_{2}\end{matrix} ]}^{T} [ \begin{matrix}{L}_{1} & {L}_{12} \\ {L}_{21} & {L}_{2}\end{matrix} ] [ \begin{matrix}{q}_{1} \\ {q}_{2}\end{matrix} ]}{{[ \begin{matrix}{q}_{1} \\ {q}_{2}\end{matrix} ]}^{T} [ \begin{matrix}{W}_{1} & \\ & {W}_{2}\end{matrix} ] [ \begin{matrix}{q}_{1} \\ {q}_{2}\end{matrix} ]} , \\ s . t . {[ \begin{matrix}{q}_{1} \\ {q}_{2}\end{matrix} ]}^{T} [ \begin{matrix}{W}_{1} & \\ & {W}_{2}\end{matrix} ] [ \begin{matrix}{e}_{1} \\ {e}_{2}\end{matrix} ] = 0$$

5. The method of claim 3 wherein the reformulated objective function is represented by the following:
$$min T ( {q}_{2} ) = \frac{{q}_{2}^{T} {L}_{2} {q}_{2} + 2 {q}_{1}^{T} {L}_{12} {q}_{2} + {q}_{1}^{T} {L}_{1} {q}_{1}}{{q}_{2}^{T} {W}_{2} {q}_{2} + {q}_{1}^{T} {W}_{1} {q}_{1}}$$
$$s . t . {q}_{2}^{T} {W}_{2} {e}_{2} + {q}_{1}^{T} {W}_{1} {e}_{1} = 0$$

6. The method of claim 1 wherein the eigenvalue decomposition solver is a preconditioned conjugate gradient solver.

7. The method of claim 1 wherein values of the eigenvector corresponding to the objects whose clusters have been determined are fixed.

8. The method of claim 7 wherein the values are fixed as represented by the following:
$${q}_{1}^{( i )} = \{ \begin{matrix}+ \sqrt{\frac{{η}_{2}}{{η}_{1}}} {q}_{1}^{( i )} > 0 \\ - \sqrt{\frac{{η}_{1}}{{η}_{2}}} {q}_{1}^{( i )} < 0\end{matrix}$$

9. The method of claim 1 including outputting an indication of the clusters of the objects.

10. A method in a computing device for clustering objects having relationships, the objects having object weights and the relationships having relationship weights, the method comprising:
applying a nonlinear eigenvalue decomposition solver to a clustering objective function for a number of iterations to generate an approximate solution represented by an eigenvector with a value for each object representing the cluster to which the object belongs, the objective function factoring in object weights and relationship weights; and
repeating the following until a termination criterion is satisfied:
identifying objects whose clusters have been determined as indicated by the values of the eigenvector;
reformulating the objective function to focus on the objects whose clusters have not yet been determined and so that the object weights dominate the relationship weights; and
applying a linear eigenvalue decomposition solver to the reformulated objective function for a number of iterations to generate an eigenvector representing an approximate solution.

11. The method of claim 10 wherein the termination criterion is satisfied when the clusters of all the objects have been determined.

12. The method of claim 10 wherein the objective function is represented by the following:
$$min \frac{{q}^{T} Lq}{{q}^{T} Wq} , s . t . {q}^{T} We = 0$$

13. The method of claim 12 wherein the reformulated objective function is represented by the following:
H(q₂)=q₂^{T}L₂q₂+2q₁^{T}L₁₂q₂+q₁^{T}L₁q₁

14. The method of claim 13 wherein the reformulating of the objective function so that the object weights dominate the relationship weights results in the objective function being linear.

15. The method of claim 10 including outputting an indication of the clusters of the objects.

16. The method of claim 10 wherein the reformulating removes a denominator of the objective function.

17. A computer-readable medium encoded with instructions for controlling a computing device to cluster objects having relationships, by a method comprising:
applying an eigenvalue decomposition solver to a clustering objective function for a number of iterations to generate an approximate solution represented by an eigenvector with a value for each object representing the cluster to which the object belongs; and
repeating the following until a termination criterion is satisfied:
identifying objects whose clusters have been determined as indicated by the values of the eigenvector;
reformulating the objective function to focus on the objects whose clusters have not yet been determined; and
applying an eigenvalue decomposition solver to the reformulated objective function for a number of iterations to generate an eigenvector representing an approximate solution.

18. The computer-readable medium of claim 17 wherein the objective function is nonlinear and the reformulated objective function is nonlinear with values of the eigenvector being fixed for the objects whose clusters have been determined.

19. The computer-readable medium of claim 17 wherein the objective function is nonlinear and the reformulated objective function is made linear by removing a denominator of the objective function.

20. The computer-readable medium of claim 17 wherein the objects have object weights and the relationships have relationship weights and the objective function is reformulated so that object weights dominate relationship weights.
